(19) United States
(12) Patent Application Publication
(10) Pub. No.: US 2006/0070932 A1
(43) Pub. Date: Apr. 6, 2006

(54) Method and device to separate particles from a mixture

(76) Inventor: Carl Gisquiere, Ieper (BE)

Correspondence Address: James C Wray, Suite 300, 1493 Chain Bridge Road, McLean, VA, 22101, US

(21) Appl. No.: 10/533,566

(22) PCT Filed: Oct. 28, 2003
(86) PCT No.: PCT/EP03/12211

§ 371 Date: May 3, 2005

(30) Foreign Application Priority Data
Nov. 6, 2002 (BE) 2002/0630

(51) Int. Cl. B07C 5/38

(52) U.S. Cl. 209/631; 209/644

(57) ABSTRACT

Method and device to separate particles from a mixture consisting of particles, the mixture being capable of moving along for a distance along the guiding surface (1,19,30) installed in an inclining position and past the discharge point (3) may be selectively collected by means of a number of collecting units (12,13,32,34) installed in different positions.

The invention relates to a method to separate particles from a mixture consisting of particles. The invention likewise relates to a device for applying such a method.

It is known to separate particles from a certain mixture by heating the mixture, so that certain particles of the mixture will soften and subsequently the softened particles may be removed from the mixture, by means of a separating element, as known from WO 93/17852, and thereby separating them from the other particles of the mixture. Applying such a method is limited to the removal of particles, which are softened under the influence of heat.

Purpose of the invention is a method and a device to separate particles from a mixture consisting of different particles enabling different particles of a mixture to be separated in a simple manner.

In order to reach that purpose the method comprises to supply the mixture to a guiding surface installed in an inclining position near a feeding point, making the mixture to move over a distance along the inclined surface from the feeding point to the discharge point of the inclined surface and to selectively collect differently moving particles of the mixture past the discharge point, by means of a number of collecting units positioned in different positions.

The method according to the invention allows to separate the different particles constituting a mixture on the basis of particles moving along a guiding surface installed in an inclining position. The distance for which the mixture is moved along the guiding surface being sufficiently long to make the different particles move along the guiding surface at an essentially different speed. Depending on the friction between the particles and the guiding surface and/or on other properties of the particles, certain particles will be moving rapidly and other particles slowly along the guiding surface. This moving along may occur by sliding, gliding, rolling, rotating or in any other way. As the different particles are moving along the guiding surface in a different way, the particles will move past the discharge point of the guiding surface in a different manner, because of which a separation on the basis of this moving along becomes possible. In this process the particles moving at a greater speed will reach a collecting unit installed further away, whereas the particles moving at a lower speed will reach a collecting unit installed less far. This will make that the particles having practically the same properties will reach a certain collecting unit and that particles having other properties will reach another collecting unit, because of which the different particles of a mixture may be separated in a simple manner.

Moreover, the method according to the invention enables to separate mixtures of any composition, and this without the necessity of subjecting the mixture, before separation, to a treatment, such as heating. Such a method is therefore especially suitable for a first separation of the mixture. The method according to the invention is particularly suitable for separating a mixture which, for instance, consists of particles produced by crushing or shredding automobile wrecks, parts of automobile wrecks, domestic appliances and other similar parts.

According to an embodiment, the particles of the mixture to be separated are first subjected to a separation on the basis of the size of the particles, before they are supplied to a guiding surface installed in an inclining position. This means that essentially particles of the same order of size are supplied to a guiding surface installed in an inclining position, which is advantageous for separating the particles supplied to the guiding surface installed in an inclining position.

According to a preferred embodiment the guiding surface installed in an inclining position is installed such that the direction of motion of the mixture supplied to the guiding surface installed in an inclining position near the feeding point, comprises a component according to the guiding surface, the direction of which is opposite to the direction of motion of the mixture when this mixture is moving along the guiding surface from the feeding point towards the discharge point. This is advantageous in order to keep the supplied mixture in contact with the guiding surface installed in an inclining position and subsequently to make this mixture to continue to move along this guiding surface in contact with the guiding surface in order to separate this mixture.

According to an embodiment, the method likewise comprises the subjecting of the mixture moving along past the discharge point to an air stream before this mixture will be collected by the different collecting units. This enables even to improve the separation of the particles of the mixture.

According to an embodiment, the method likewise comprises the adjusting of the inclination of the guiding surface installed in an inclining position. This enables to adjust the inclination as a function of the nature of the mixture to be separated, more particularly as a function of the properties of the material of the particles and as a function of the condition and the properties of the particles. This enables, for instance, to choose a steeper inclination when the mixture is in a wet condition than when it is in a drier condition. When a spherical shape is a property of the particles, for instance, a less steep inclination may be chosen than with particles having rather flat exterior surfaces.

According to an embodiment, the method likewise comprises the moving back and forth of the guiding surface installed in an inclining position. This will enable to influence the moving along of the mixture along the guiding surface installed in an inclining position and to obtain a good separation of the mixture, even with a relatively short guiding surface installed in an inclining position.

For the purpose of the invention, the invention likewise comprises a device for applying aforesaid method comprising a guiding surface installed in an inclining position to make a mixture to move along between a feeding point and a discharge point, situated at a distance from the feeding point of the guiding surface installed in an inclining position, a feeding device to supply a mixture near the feeding point of the guiding surface installed in an inclining position and a number of collecting units, installed in different positions past the discharge point of the guiding surface installed in an inclining position for selectively collecting particles of the mixture moving differently.

According to an embodiment, the feeding device comprises a vibrating table, which comprises at least one opening, that is situated between the extremities of the vibrating table and that is installed above a guiding surface installed in an inclining position in order to let pass particles of a certain size from the vibrating table to the guiding surface installed in an inclining position. Preferably the size of the at least one opening is adjustable. Because of this only particles up to a certain size are supplied to the aforesaid guiding surface installed in an inclining position, which is advantageous for separating these particles using a method according to the invention. The remaining particles may be supplied to another guiding surface installed in an inclining position through openings of the vibrating table situated in other places or near the extremity of the vibrating table.

According to an embodiment, the distance between the discharge point of the mixture of the feeding device and the feeding point for the mixture of the guiding surface installed in an inclining position is of the order of magnitude of 0.15 metres. This enables the mixture not essentially to rebound from the guiding surface when it is supplied to the guiding surface, because of which the mixture will be essentially moving along the guiding surface and a separation of the particles of the mixture will be obtained, according to the method according to the invention. In order to obtain a separation of a mixture by means of a method according to the invention, it is advantageous that the mixture will not fall essentially between the feeding device and the guiding surface installed in an inclining position.

According to an embodiment, the guiding surface installed in an inclining position is consisting of a plate provided with side flanges having an essentially flat bottom surface.

According to another embodiment, the guiding surface installed in an inclining position is consisting of a plate provided with side flanges having an essentially slightly curved bottom surface in the longitudinal direction running from the feeding point to the discharge point, at least for a certain distance. By choosing such a slightly curved concave or convex bottom surface the difference in moving speed of the different particles may be influenced.

According to an embodiment, at least part of the bottom surface of the guiding surface installed in an inclining position is uneven or rough. Such an uneven or rough bottom surface may be able to influence the difference in moving speed of the different particles, more particularly this may cause hard particles to move faster and soft particles to move somewhat less fast than in case they would be moving along a guiding surface having a smooth or polished bottom surface.

According to yet another embodiment, at least part of the bottom surface of the guiding surface installed in an inclining position is provided with blow openings. For that purpose the guiding surface may consist of a plate, which has several drilled holes or perforations, which are connected, to a source of compressed air. This enables a similar guiding surface to form an air cushion for the mixture when the device is working. This may also influence the difference in moving speed of the different particles. This may be applied especially to separate a mixture consisting of particles causing a relatively strong friction between the particles and the guiding surface.

According to a preferred embodiment the guiding surface installed in an inclining position forms an angle of between 30° and 40° with a horizontal. This is advantageous for making the mixture to move along the guiding surface. Such an arrangement likewise has the advantage that after supplying the mixture onto the guiding surface, this mixture will essentially remain in contact with the guiding surface and will move along this guiding surface.

According to an embodiment the guiding surface installed in an inclining position forms an angle of about 32° with a horizontal. Such an arrangement yields good results in case a device according to the invention is applied for separating plastics from other materials, such as textile fibres and foamed rubber originating from a mixture of crushed parts of automobile wrecks.

According to an embodiment, the device comprises adjusting parts in order to adjust the inclination of the guiding surface installed in an inclining position. This enables the inclination to be adjusted as a function of the material to be separated.

According to yet another embodiment, the guiding surface installed in an inclining position is part of a vibrating table, moving the guiding surface installed in an inclining position essentially back and forth, according to its longitudinal direction. This may influence the difference in moving speed and the separation of the different particles.

According to an embodiment, the guiding surface installed in an inclining position is installed under the aforesaid feeding device, in such a manner that the direction of motion of the mixture supplied onto the guiding surface installed in an inclining position near the feeding point comprises a component according to the guiding surface in a direction being opposite to the direction of motion of the mixture along the guiding surface, when this mixture is moving along the guiding surface from the feeding point to the discharge point. This disposition enables a compact construction of the device according to the invention.

According to an embodiment, at least one collecting unit comprises at least one adjustable separating wall enabling the position of the at least one collecting unit to be adjusted with respect to the discharge point of the guiding surface. Preferably, such a separating wall is rotatable around an axis running parallel to the cross direction of the guiding surface installed in an inclining position. By making the separating wall adjustable it is possible to install the separating wall such that a desired separation of the particles occurs, more particularly that the particles desired will fall into the collecting unit desired.

According to an embodiment, the device according to the invention likewise comprises an apparatus to create an air stream in the area between the discharge point of the guiding surface installed in an inclining position and the different collecting units. This may enable to favour the separation of the particles having different properties, such as weight and shape. Under the influence of the air stream it may be obtained; for instance, that the different particles, which are moving even at about the same speed along the guiding surface, may still perform a different falling motion and thereby end up in a different collecting unit.

According to an embodiment, at least one of the collecting units consists of a second guiding surface installed in an inclining position in order to collect particles of the mixture from a first guiding surface installed in an inclining position, functioning as a feeding device for feeding the mixture to a second guiding surface installed in an inclining position.

The characteristics and further advantages of the invention will be further explained on the basis of non-restricting exemplifying embodiments represented in the attached drawings in the following detailed description. In this description reference is made to the following drawings in which:

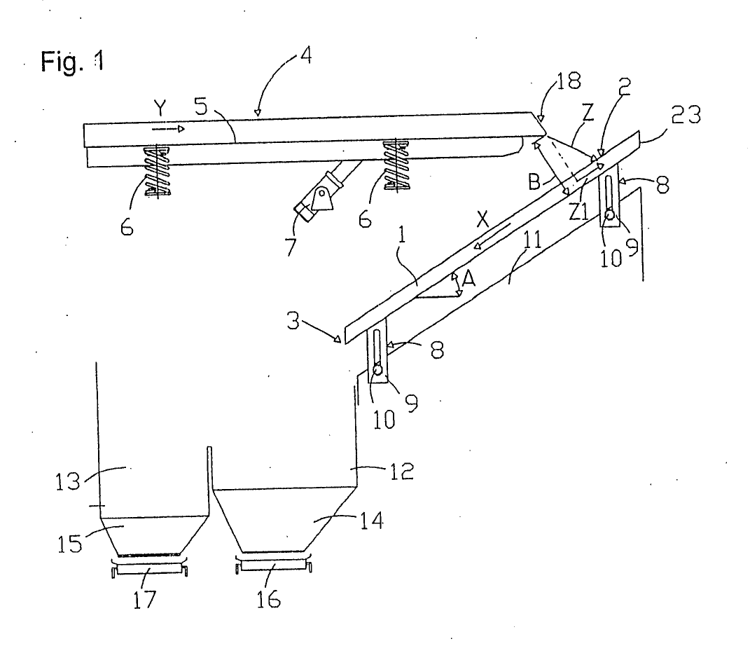

FIG. 1 represents a side elevation of a device according to the invention;

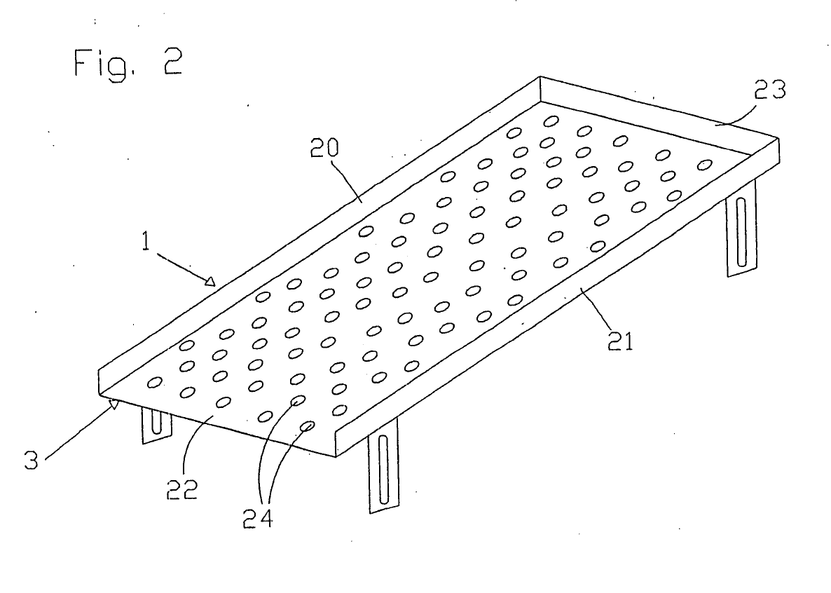

FIG. 2 represents in perspective the guiding surface of FIG. 1;

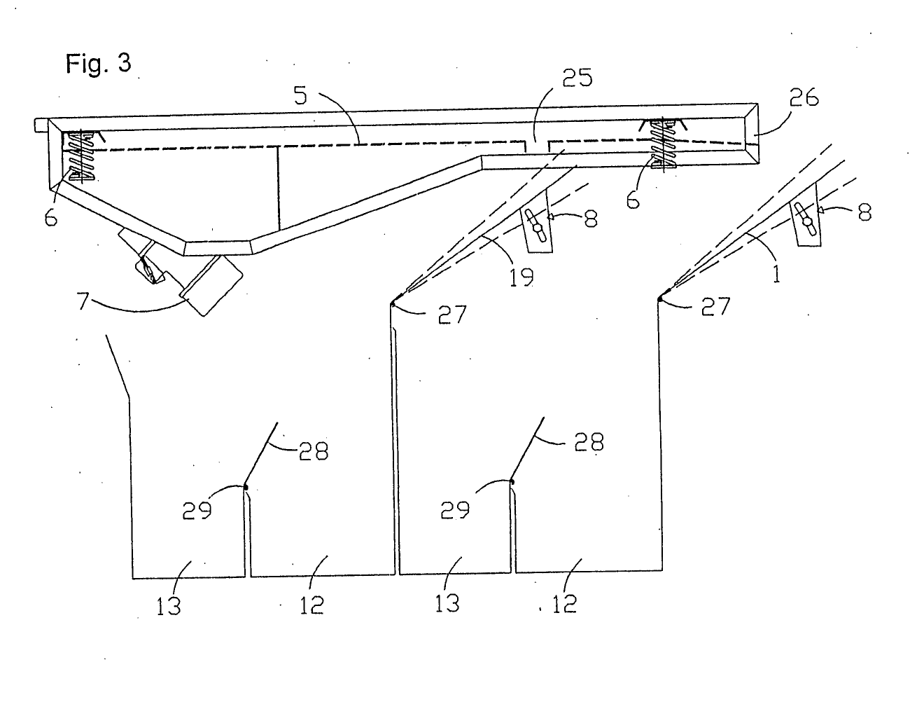

FIG. 3 represents a variant of the device represented in FIG. 1;

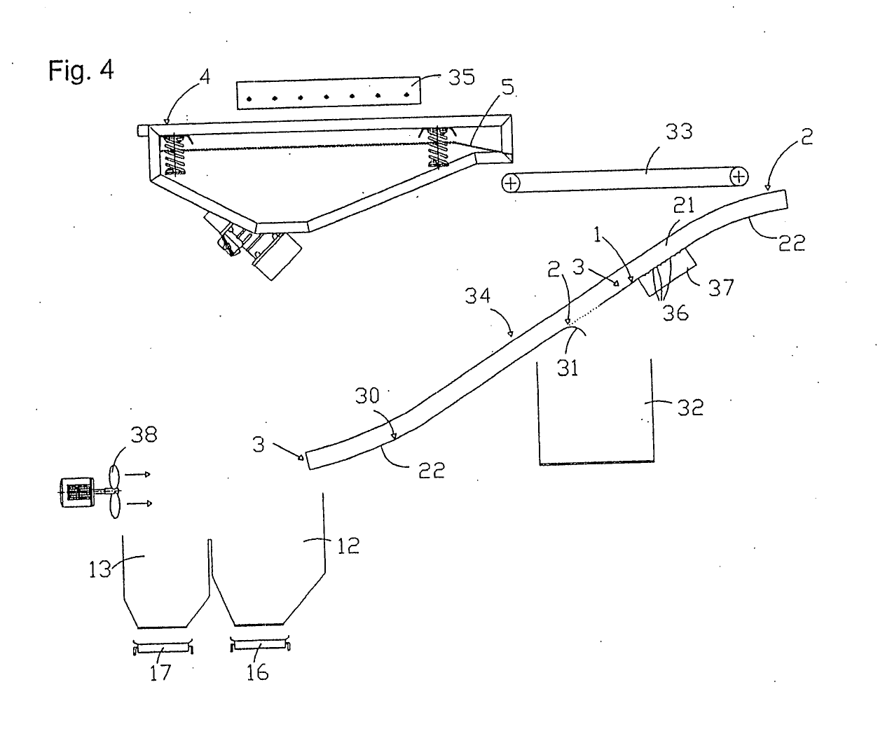

FIG. 4 represents another variant of the device represented in FIG. 1;

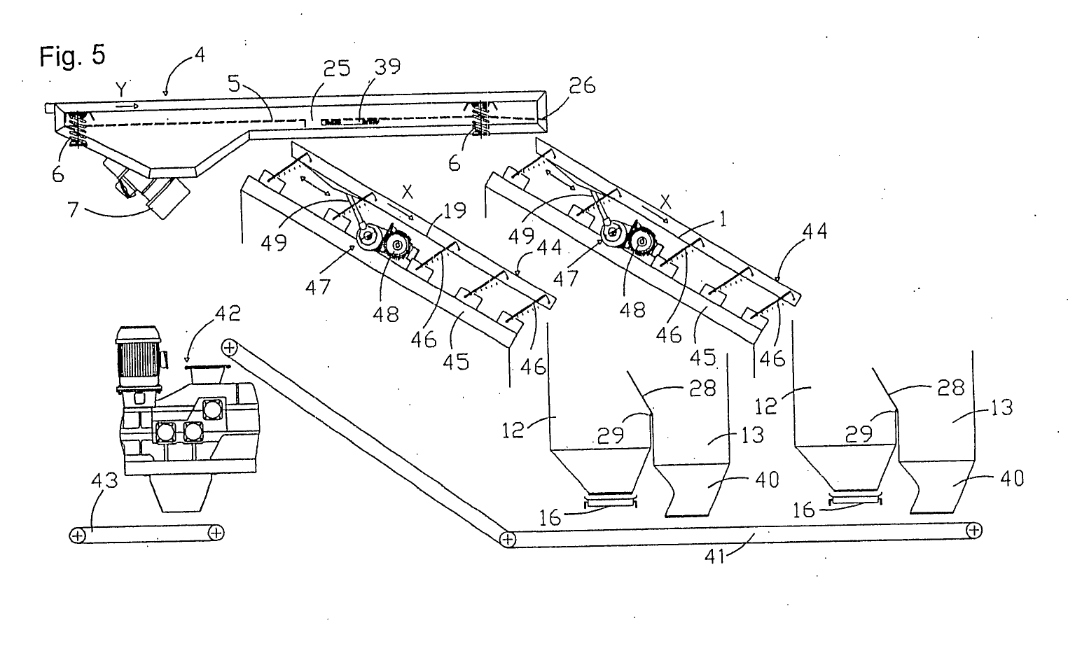

FIG. 5 represents yet another variant of the device represented in FIG. 1;

The device according to the invention represented in FIG. 1 comprises a guiding surface 1 installed in an inclining position for making a mixture to move over a distance along this guiding surface 1 between a feeding point 2 and a discharge point 3 of the guiding surface 1. Furthermore, a feeding device 4 is represented, comprising a vibrating table 5 for feeding the mixture to the guiding surface 1 near the feeding point 2. On its sides, the vibrating table 5 is supported by springs 6 and is moved back and forth by a driving unit 7, which comprises, for instance, a driving element and a transmission mechanism in order to lead a mixture according to a direction of motion Y to the guiding surface 1. On one side, the springs 6 are attached to a frame, which is not represented, to which also the driving unit 7 is attached and on their other sides they are attached to the vibrating table 5. Because of the vibrating table 5 the mixture is spread out across the width of the vibrating table 5, because of which the mixture is likewise supplied to the guiding surface 1 across its width.

In the example represented, the guiding surface 1 is inclined at an angle A of about 32° with respect to the horizontal. Furthermore the adjusting parts 8 to adjust the inclination of the guiding surface 1 are represented, which in the example represented, are consisting of a plate 9 provided with a groove through which a bolt 10 passes, which may be tightened to the frame 11 when the groove reaches a certain position. This enables, for instance, the inclination or the angle A of the guiding surface installed in an inclining position to be adjusted in a simple manner between, for instance, 30° and 40°. This likewise enables the position of the guiding surface 1 installed in an inclining position to be adjusted with respect to the vibrating table 5.

Furthermore, the device comprises two collecting units 12 and 13 for selectively collecting particles of the mixture, which are installed in a different position past the discharge point 3 according to the direction of motion X. The direction of motion X being destined as the direction from the feeding point 2 to the discharge point 3 according to the longitudinal direction of the guiding surface 1. In this embodiment, the collecting units 12 and 13 have the form of funnel-shaped units, comprising a guide 14 or 15 at the bottom to conduct collected particles of the mixture to a belt conveyor 16 or 17.

Hereby, the guiding surface 1 installed in an inclining position is situated under the feeding device 4, such that the direction of motion Z of the mixture supplied to the guiding surface 1 installed in an inclining position, near the feeding point, has a component Z1 according to the guiding surface 1 in the opposite direction to the direction of motion X of the mixture along the guiding surface 1 when this mixture is moving along this guiding surface 1. This enables a compact construction of the device.

When the device according to the invention is working, the mixture is conducted from the feeding device 4, along the guiding surface 1, to the different collecting units 12 and 13. Depending on the manner in which the different particles are co-operating with the guiding surface 1, they will move differently along this guiding surface 1 and differently past the discharge point 3. Once they have passed this discharge point 3, these particles will make a falling motion which is determined, by the motion with which the particles are moving along the guiding surface. 1 to the discharge point 3 and also by the environment in which these particles are falling past the discharge point 3. Depending on their falling motion, certain particles will fall into the collecting unit 12 and other particles in the collecting unit 13, so that the different particles of the mixture are separated.

A mixture intended to be separated according to the invention, may consist of a mixture of bulk material essentially consisting of particles having a size situated between 10 and 100 mm. This mixture may originate from crushed parts of automobile wrecks and may consist of, for instance, plastic, foamed rubber, rubber, textile fibres and other materials. It has been experimentally found that particles of such mixtures having different properties may be well separated by making use of a guiding surface 1 which is installed at an angle of about 32°. Of course, the mixtures to be separated are not restricted to mixtures originating from crushed automobile wrecks or other crushed parts of motorcars. The mixture of particles may likewise originate from crushed domestic appliances, computers or other parts. The particles may be of any shape or size.

As represented in the FIGS. 1 and 2 the guiding surface 1 consists of a plate provided with side flanges 20 and 21, comprising an essentially flat bottom surface 22. Near the feeding point 2 the plate comprises yet another flange 23. The plate may be made of a metal, for instance, aluminium, or stainless steel such as inox. The bottom surface 22 may be polished. In an embodiment, the bottom surface is rough or uneven, more particularly, the bottom surface 22 is provided with several bulges 24 as schematically represented in FIG. 2. According to a variant not represented only part of the bottom is made uneven or rough and the remaining part is practically even. The width of the bottom surface 22 of the embodiment represented, amounts to about 900 mm and the side flanges 20 and 21 here have a height of about 100 mm. The length of the guiding surface lies, for instance, between about 1000 mm and about 2500 mm. Such a device is intended to separate a mixture having an output of 500 kg/hour, for instance, a certain particle of the mixture, for instance being near the guiding surface 1 during three to six seconds.

The distance B (FIG. 1) between the discharge point 18 of the feeding device 4 and the guiding surface 1 amounting here to about 0.15 metres. It is advantageous to keep this distance relatively small in order to limit bouncing and rebounding of the particles on the guiding surface 1. The component Z1 being opposite to the direction of motion X is also advantageous to limit rebounding. Of course, the distance B should have a minimal value in order to prevent the vibration table 5 from colliding with the guiding surface 1. In the aforesaid arrangement, the distance should likewise have a minimal value in order to always obtain that all particles will be able to pass between the vibrating table 5 and the guiding surface 1.

The open structure of the device according to the invention, and especially of the guiding surface 1 imposes little restrictions on the mixture supplied and allows of a very quick change of the mixture supplied. Also, the guiding surface 1 may be cleaned in a simple manner, for instance, in case the nature of the mixture supplied will be changed. As there may be a certain friction between the guiding surface 1 and the mixture, static electricity may be produced which means that it is advisable for the guiding surface 1 to be earthed.

In FIG. 3, an embodiment is represented where the vibrating table 5 has an opening 25, that is situated between the extreme extremities of the vibrating table 5 and that is situated above a first guiding surface 19 installed in an inclining position. This opening 25 enables certain particles, more particularly particles up to a certain size to pass through the opening 25 towards the guiding surface 19. The remaining particles may be brought, from the extremity 26 of the vibrating table 5 onto a second guiding surface 1 in a manner, which is, analogous to the one represented in FIG. 1. In this manner it is possible to first separate the particles of the mixture to be separated supplied to the vibrating table 5 on the basis of size and in this manner to conduct essentially particles of the same order of size to a guiding surface 1 and 19 installed in an inclining position respectively. For instance, the guiding surfaces 1 and 19 each are rotatable around an axis 27 directed crosswise with respect to the guiding surface 1 and may be adjusted in any position between the broken lines indicated in FIG. 3, for instance, by means of adjusting parts 8 analogous to those represented in FIG. 1.

As further represented in FIG. 3, each collecting unit 13 comprises an adjustable separating wall 28 allowing to adjust the position of the collecting unit 13 with respect to the discharge point 3 of the guiding surface 1. The separating wall 28 is rotatable around an axis 29 running parallel to the cross direction of the guiding surface 1. By adjusting the separating wall 28 in a different angle position it is possible to obtain that more or less particles will end up in the collecting unit 13 and in doing so more or less particles will end up in collecting unit 12. According to a variant not represented, the separating wall 28 may be provided on the collecting unit 12.

In FIG. 4, an embodiment is represented in which two guiding surfaces 1 and 30 have been provided, the second guiding surface 30 functioning as a collecting unit 34 for particles from the first guiding surface 1 and the guiding surface 1 functioning as a feeding device for supplying particles from a mixture to a second guiding surface 30 installed in an inclining position. In this embodiment, both guiding surfaces 1 and 30 are consisting of a same plate provided with side flanges 21. Of the bottom surface of that plate a part 31 extending crosswise is bent, in order to be able to form two different guiding surfaces 1 and 30. Because of this the particles of the mixture moving relatively slowly along the guiding surface 1, past the discharge point 3 of the guiding surface 1 will be collected by the collecting unit 32, whereas particles moving relatively faster may be collected by the guiding surface 30 acting as the collecting unit 34 and subsequently will move further on along this guiding surface 30 to be subsequently collected by one of the collecting units 12 and 13. The collecting unit 32, for instance, consisting of a container.

In the embodiment of FIG. 4, the feeding device 4 comprises a vibrating table 5 that may supply the mixture to a belt conveyor 33 that may subsequently supply the mixture to the guiding surface 1. Using a vibrating table 5 is advisable in order to spread the mixture over the entire width of both belt conveyor 33 and guiding surface 1. It is, of course, also possible to provide a heating element 35 above the vibrating table 5 in order to dry or to heat the mixture to be separated. By drying or heating, the behaviour of certain particles may be still influenced when these particles are moving along the guiding surface 1 or 30, giving an additional possibility to separate particles from a certain mixture. This is more especially the case with particles being formed under the influence of thermoplastic parts of synthetic material that soften under influence of temperature, which, after having been heated to become softened, will normally move more slowly along a guiding surface 1 or 30 than in case they would not have been softened. In this case, a heating element 35 can be used, consisting of an infrared source for heat radiation, able to heat essentially and selectively certain thermoplastic parts of synthetic material.

As can likewise be seen in FIG. 4, the bottom surface 22 of the guiding surface 1 is slightly curved according to the longitudinal direction. A similar curve enables to reduce the initial acceleration of the particles and in doing so to influence the differences in speed of motion of different particles. The bottom surface 22 of the guiding surface 30 is likewise slightly curved according to the longitudinal direction of the guiding surface 30, however, in the other direction. This enables to reduce the final acceleration of the particles and in doing so likewise to influence the differences in the moving speed of the different particles. This results in another falling motion, more particularly in another falling angle of the different particles.

The bottom surface 22 of at least one of the two guiding surfaces 1 or 30 may be even, uneven or rough. As schematically represented in FIG. 4, also at least part of the bottom surface, made in the form of a plate, of the guiding surface 1 installed in an inclining position may be provided with a number of blow openings 36, which, for instance are in the shape of drilled holes or perforations in the guiding surface 1, which are connected to a source of compressed air 37. The source of compressed air 37 consists, for instance, of a pressure vessel, the upper wall of which consists of the part of the guiding surface 1 provided with drilled holes 36. This allows of an air cushion for the mixture to be formed under the influence of the compressed air during operation, because of which the particles are less slowed down by friction on the guiding surface 1, which may be advantageous, especially for particles which normally cause a high friction on the guiding surface 1. According to a variant not represented, more than two similar guiding surfaces 1 and 30 may be likewise installed practically in line.

De device of FIG. 4 likewise comprises an apparatus 38, such as, for instance, a fan to create an air stream in the area between the discharge point 3 of the guiding surface 30 installed in an inclining position and the different collecting units 12 and 13. This may even influence the separation of the different particles from the mixture, resulting in certain particles subjected to the air stream to end up in collecting unit 12 or 13, depending on the manner in which the falling motion is influenced by the air stream.

In FIG. 5, yet another embodiment is represented, in which the feeding device 4 comprises a vibrating table 5 having an opening 25 and an adjustable slide 39, installed according to the longitudinal direction of the vibrating table 5. It is obvious that the slide 39, at the same time, is part of the vibrating table 5. By adjusting the slide 39 in a different position according to the direction of motion Y, the size of the opening 25 may be adjusted. This enables to adjust the size of the particles admitted to the guiding surface 19. The larger particles are supplied to the guiding surface 1 in a manner analogous to the one represented in FIG. 3. According to a variant not represented, several similar openings may be provided along the vibrating table 5 spaced from one another according to the direction of motion Y of the mixture, each co-operating with an accompanying guiding surface and the size of the respective openings increasing according to the aforesaid direction of motion Y, so that first the smaller particles will fall through an opening.

Certain particles being moved along the guiding surface 1 and as well as those moving along the guiding surface 19 are collected by a respective collecting unit 12. Next to each collecting unit 12 a collecting unit 13 is installed collecting particles from the guiding surface 19 or from the guiding surface 1 respectively. Both collecting units 13 have guides 40 being able to conduct the particles collected by this collecting units 13 to the belt conveyor 41. Because of this disposition, particles of different sizes, after having been moved along the different guiding surfaces 1 or 19, are either conducted to the accompanying belt conveyor 16 via a collecting unit 12, or after having been collected by a different collecting unit 13, are put together again on one single belt conveyor 41. This is advantageous to separate a mixture of different materials, in particular, to separate particles of certain materials from particles of other materials. This is especially advantageous because it has been found that particles from different materials and having dimensions of the same order of size may be better separated on the basis of different materials by means of a device according to the invention than in case particles of any dimensions are supplied together to one single guiding surface.

The device of FIG. 5 also comprises separating walls 28, with which the collecting units 13 have been provided and which are each rotatable around an axis 29. In the device of FIG. 5, the guiding surfaces 1 and 19 are installed directed such, that the direction of motion X of the mixture along the guiding surfaces 1 and 19 is the same as the direction of motion Y of the mixture moving along the feeding device 4. The particles being conducted to the belt conveyor 41, for instance, consist of plastic and are conducted to a crushing device 42 at a point past the belt conveyor 41. Subsequently, these particles are crushed by the crushing device 42 and in the example represented, a mixture consisting of particles having practically the same dimensions may be formed, that may, for instance, be conveyed further on via another belt conveyor 43.

In FIG. 5, the guiding surfaces 1 and 19 are each part of a vibrating table 44 installed in an inclining position. Each vibrating table 44 consists of a frame 45, fixedly installed, which is connected to the guiding surfaces 1 and 19 by means of springs, more particularly leaf springs 46.

Between the frame 45 and the guiding surfaces 1 and 19 a drive unit 47 has likewise been provided, comprising a drive motor 48 and a connecting rod 49 and which is able to move the guiding surfaces 1 and 19 back and forth essentially according to their longitudinal direction. The drive and the disposition of the guiding surfaces 1 and 19, acting as a vibrating table, is preferably such that under the influence of the motion of the guiding surfaces 1 or 19 the mixture is forced in a direction opposite to the direction of motion X. The aforesaid direction is, among others, determined by the angle of inclination between the leaf springs 46 and the guiding surfaces 1 and 19 carried out as a vibrating table. Because of this, the mixture is moving down along the guiding surfaces 1 and 19 installed in an inclining position relatively slowly, more particularly, the motion of mixture along the guiding surfaces 1 and 19 is obstructed or slowed down by the vibrating movement of these guiding surfaces 1 and 19. This makes it possible to obtain nevertheless a relatively great differences in moving speed of the different particles of the mixture at a relatively short guiding surface 1 or 19, because of which a good separation of the mixture is realized by means of such a device according to the invention.

Of course, the angle of inclination of the leaf springs according to a variant not represented, may also be chosen to be opposite to the one of FIG. 5, because of which the mixture will be moving still faster along the guiding surface 1 or 19. This may be used, for instance, to separate materials, sliding very difficultly, by means of a device according to the invention.

Providing a curved bottom surface according to the direction of motion X of the mixture or a bottom surface with an uneven or rough bottom surface or a bottom surface with blow openings or a bottom surface vibratingly installed, is advantageous to obtain, that already by moving the mixture for a relatively short distance along this bottom surface, already considerable differences in moving speed of the different particles may yet be obtained. Because of this it is nevertheless possible to obtain a good separation of the mixture with a relatively compact device, more particularly with a relatively short guiding surface, for instance, in the order of magnitude of one or a few metres.

It is, of course, possible to improve the separation of particles by reconducting certain particles selectively collected by means of a collecting unit according to the invention back to a device according to the invention, where a next subsequent analogous separation of the particles will be carried out. If the different particles, already partly separated by means of a preceding device according to the invention, are supplied several times to a next device according to the invention, it will be obvious that the different particles will be separated at a better efficiency.

If, for instance, the mixture comprises some different kinds of particles, for instance, four kinds of particles such as plastic, foamed rubber, rubber and textile fibres originating from crushed parts of automobile wrecks, the collecting units at a first separation may be arranged such, that the most distant collecting units with respect to the guiding surface will essentially collect the plastic particles which are moving more rapidly or are slowed down less because of frictional resistance, whereas a second collecting unit, installed closer to the guiding surface will collect foamed rubber, rubber and textile fibres. The latter mixture of foamed rubber, rubber and textile fibres than may be supplied to a second device according to the invention comprising whether or not a longer or a shorter guiding surface or a guiding surface installed at another angle and which comprises collecting units installed in a different way, so that may be obtained that foamed rubber, rubber and textile fibres are essentially collected by different collecting units.

It was likewise found that after separating particles by means of a method according to the invention, removing metal from the already separated particles of the mixture, may be obtained in a correct manner. It was found that, if textile fibres together with metal and foamed rubber are previously separated by means of a method according to the invention, it is simply possible to separate metal from the remaining mixture of textile fibres and metal. This can be done, for instance, in an electromagnetic manner. This separation is simpler when this mixture essentially contains textile fibres and metal and no or little foamed rubber, in other words when the foamed rubber was previously removed by means of a method according to the invention.

Further advantages of the device according to the invention are its simple construction, because of which it is not only advantageous as to maintenance and cleaning of this device, but it may likewise be built at a favourable low price. The device likewise only comprises parts of a simple design, which may be assembled to form a sturdy construction, which is advantageous in an environment where bulk material is recycled. This likewise enables the device according to the invention to separate practically any particles from a mixture.

The method according to the invention which may be applied by making use of a device according to the invention, and the device according to the invention which is designed to be able to apply the method according to the invention are obviously not restricted to the embodiments described in the examples, but may likewise comprise variants and combinations of these embodiments.

1. Method to separate particles from a mixture consisting of particles, characterized in that the method comprises supplying the mixture near a feeding point (2) of a guiding surface (1,19,30) installed in an inclining position, making the mixture to move for a distance along the guiding surface (1,19,30) installed in an inclining position from the feeding point (2) to a discharge point (3) of the guiding surface (1,19,30) installed in an inclining position and selectively collecting particles of the mixture differently moving along past the discharge point (3) by means of a number of collecting units (12,13,32,34) that are installed in different positions.

2. Method according to claim 1, characterized in that the particles of the mixture to be separated, first are subjected to a separation on the basis of the size of the particles before being supplied to the guiding surface (1,19,30) installed in an inclining position.

3. Method according to claim 1, characterized in that the guiding surface (1,19,30) installed in an inclining position is installed such that the direction of motion (Z) of the mixture supplied to the guiding surface (1,19,30) installed in an inclining position near the feeding point (2), comprises a component (Z1) according to the guiding surface (1,19,30) which is directed opposite to the direction of motion (X) of the mixture along the guiding surface (1,19,39) when this mixture is moving along from the feeding point (2) to the discharge point (3).

4. Method according to claim 1, characterized in that the method comprises the subjecting of the mixture moving along past the discharge point (3) to an air stream, before this mixture is collected by the different collecting units (12,13).

5. Method according to claim 1, characterized in that the method comprises the adjusting of the inclination (A) of the guiding surface (1,19,30) installed in an inclining position.

6. Method according to claim 1, characterized in that the method comprises the moving back and forth of the guiding surface (1,19) installed in an inclining position.

7. Device for applying the method according to claim 1, characterized in that the device comprises a guiding surface (1,19,30) installed in an inclining position to make a mixture to move along between a feeding point (2) and a discharge point (3) of the guiding surface (1,19,30) installed in an inclining position, situated at a distance of the feeding point (2), a feeding device (4) for supplying a mixture near the feeding point (2) of the guiding surface (1,19,30) installed in an inclining position and a number of collecting units (12,13,32,34) situated in different positions past the discharge point (3) of the guiding surface (1,19,30) installed in an inclining position in order to selectively collect different particles of the mixture differently moving along.

8. Device according to claim 7, characterized in that the feeding device (4) comprises a vibrating table (5) which comprises at least one opening (25), situated between the extremities of the vibrating table (5) and which is installed above a guiding surface (19) installed in an inclining position for making particles of a certain size to pass from the vibrating table (5) to the guiding surface (1,19,30) installed in an inclining position.

9. Device according to claim 8, characterized in that the size of the at least one opening (25) is adjustable.

10. Device according to claim 7, characterized in that the distance between the discharge point (26) for the mixture from the feeding device (4) and the feeding point (2) for the mixture from the guiding surface (1,9) installed in an inclining position is of the order of magnitude of 0.15 metres.

11. Device according to claim 7, characterized in that the guiding surface (1,19,30) installed in an inclining position is consisting of a plate provided with side flanges (20,21) comprising an essentially flat bottom surface (22).

12. Device according to claim 7, characterized in that the guiding surface (1,19,30) installed in an inclining position is consisting of a plate provided with side flanges (20,21), which, according to a longitudinal direction from the feeding point (2) to the discharge point (3) comprises a bottom surface (22) which is essentially slightly curved, at least for a certain distance.

13. Device according to claim 7, characterized in that at least part of the bottom surface (22) of the guiding surface (1,19,30) installed in an inclining position is uneven or rough.

14. Device according to claim 7, characterized in that at least part of the bottom surface (22) of the guiding surface (1) installed in an inclining position is provided with blow openings (36).

15. Device according to claim 7, characterized in that the guiding surface (1,19,30) installed in an inclining position is situated at an angle lying between 30° and 40° with respect to a horizontal.

16. Device according to claim 7, characterized in that the guiding surface (1,19,30) installed in an inclining position is situated at an angle of the order of magnitude of 32° with respect to a horizontal.

17. Device according to claim 7, characterized in that the device comprises adjusting parts (8) for adjusting the inclination (A) of the guiding surface (1,19,30) installed in an inclining position.

18. Device according to claim 7, characterized in that the guiding surface (1,19) installed in an inclining position is part of a vibrating table (44) moving the guiding surface (1,19) installed in an inclining position back and forth essentially according its longitudinal direction.

19. Device according to claim 7, characterized in that the guiding surface (1,19,30) installed in an inclining position is installed under the aforesaid feeding device (4), such that the direction of motion (Z) of the mixture supplied to the guiding surface (1,19,30) installed in an inclining position near the feeding point (2) comprises a component (Z1) according to the guiding surface (1,19,30) which is directed opposite to the direction of motion (X) of the mixture along the guiding surface (1,19,30) when this mixture is moving along from the feeding point (2) to the discharge point (3).

20. Device according to claim 7, characterized in that at least one collecting unit (13) comprises at least one adjustable separating wall (28) enabling to adjust the position of the at least one collecting unit (13) with respect to the discharge point (3) of the guiding surface (1,19,30).

21. Device according to claim 20, characterized in that such a separating wall (28) is installed rotatably around an axis (29) running parallel to the cross direction of the guiding surface (1,19,30) installed in an inclining position.

22. Device according to claim 7, characterized in that the device likewise comprises an apparatus (38) to create an air stream in the area between the discharge point (3) of the guiding surface (30) installed in an inclining position and the different collecting units (12,13).

23. Device according to claim 7, characterized in that at least one of the collecting units (34) is consisting of a second guiding surface (30) installed in an inclining position for collecting particles of the mixture from the first guiding surface (1) installed in an inclining position, acting as a feeding device for supplying the mixture to the second guiding surface (30) installed in an inclining position.
